(19) United States
(12) Patent Application Publication
(10) Pub. No.: US 2026/0299384 A1
(43) Pub. Date: Oct. 1, 2026

(54) PROJECTOR

(71) Applicant: SEIKO EPSON CORPORATION, Tokyo (JP)

(72) Inventors: Nobuyuki OTSUKI, Matsumoto-shi (JP); Naoki HAYASHI, Azumino-shi (JP); Kenichi SHIOIRI, Omachi-shi (JP)

(21) Appl. No.: 19/634,594

(22) Filed: Mar. 31, 2026

(30) Foreign Application Priority Data
Apr. 1, 2025 (JP) 2025-060474

(51) Int. Cl. G03B 21/14; G03B 21/16; H04R 1/02; H04R 1/40; H04R 5/02

(52) U.S. Cl. CPC G03B 21/145; G03B 21/16; H04R 1/025; H04R 1/028; H04R 1/403; H04R 5/02; H04R 2499/15

(57) ABSTRACT

According to an aspect of the present disclosure, there is provided a projector including a light source device, an image forming device, a projection optical device, a first sound wave generation device, and a second sound wave generation device. The first sound wave generation device includes a first speaker configured to emit a first sound wave and a speaker housing supporting the first speaker, the second sound wave generation device includes a second speaker not supported by the speaker housing and configured to emit a second sound wave, a first direction in which the first sound wave generation device emits the first sound wave and a second direction in which the second sound wave generation device emits the second sound wave are respectively different from a projection direction, and an angle formed by the first direction and the second direction is 90 degrees or more.

The present application is based on, and claims priority from JP Application Serial Number 2025-060474, filed April 1, 2025, the disclosure of which is hereby incorporated by reference herein in its entirety.

### BACKGROUND

### 1. Technical Field

The present disclosure relates to a projector.

### 2. Related Art

In the related art, there has been known a projector in which a speaker is disposed in an exterior housing (see, for example, JP-A-2024-158962 described below). In the projector described above, the speaker is disposed on a rear side opposite to a front side on which an image is projected.

JP-A-2024-158962 is an example of the related art.

In the projector described above, since the speaker disposed on the rear side has a size corresponding to the entire region on the rear side of the exterior housing, there is a problem in that the projector is easily increased in size. Thus, it is desired to provide a new technique that can implement improvement of sound quality while reducing a device configuration in size.

### SUMMARY

According to an aspect of the present disclosure, there is provided a projector including: a light source device; an image forming device configured to generate image light from light emitted from the light source device; a projection optical device configured to project the image light emitted from the image forming device; a first sound wave generation device configured to emit a first sound wave; and a second sound wave generation device provided independently of the first sound wave generation device and configured to emit a second sound wave, wherein the first sound wave generation device includes: a first speaker configured to emit the first sound wave; and a speaker housing supporting the first speaker, the second sound wave generation device includes a second speaker not supported by the speaker housing and configured to emit the second sound wave, a first direction in which the first sound wave generation device emits the first sound wave and a second direction in which the second sound wave generation device emits the second sound wave are respectively different from a projection direction of the image light in the projection optical device, and an angle formed by the first direction and the second direction is 90 degrees or more.

### BRIEF DESCRIPTION OF THE DRAWINGS

FIG. 1 is a schematic configuration diagram of a projector according to an embodiment.

FIG. 2 is a perspective view illustrating a main part of an attachment structure for a first speaker device.

FIG. 3 is a cross-sectional view by a III-III line arrow view of FIG. 1.

FIG. 4 is a plan view illustrating a main part configuration of a bottom wall section.

### DESCRIPTION OF EMBODIMENTS

An embodiment of the present disclosure is explained in detail below with reference to the drawings. In the drawings referred to in the following explanation, characteristic portions are sometimes enlarged and illustrated for convenience in order to clearly explain characteristics, and dimension ratios and the like of elements are not always the same as actual dimension ratios and the like.

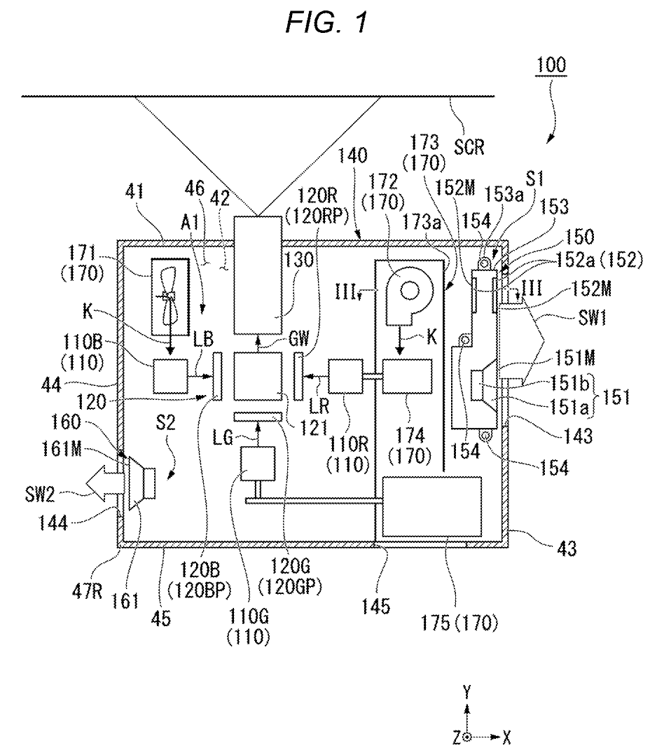

FIG. 1 is a schematic configuration diagram of a projector 100 in the present embodiment.

As illustrated in FIG. 1, the projector 100 in the present embodiment includes a light source device 110, an image forming device 120, a projection optical device 130, an exterior housing 140, a first speaker device (a first sound wave generation device) 150, a second speaker device (a second sound wave generation device) 160, and a cooling device 170.

In the following explanation, a disposition relationship among members is sometimes explained using an XYZ coordinate system illustrated in the drawings. In the drawings, a Y axis is an axis extending in a direction in which the projector 100 projects an image. An X axis is an axis orthogonal to the Y axis and is an axis extending in the width direction of a screen SCR, which is a projection surface onto which the image is projected. A Z axis is an axis orthogonal to the X axis and the Y axis and extending along the normal line of an installation surface on which the projector 100 is installed.

In the present embodiment, for example, both directions along the Z axis are collectively referred to as "up-down direction Z", a direction toward a +Z direction is referred to as "upper side", and a direction toward a -Z direction is referred to as "lower side" in the projector 100. Both directions along the X axis are collectively referred to as "left-right direction X", a direction toward a +X direction is referred to as "right side", and a direction toward a -X direction is referred to as "left side" in the projector 100. Both directions along the Y axis are sometimes collectively referred to as "front-rear direction Y", a direction toward a +Y direction is sometimes referred to as "front side", and a direction toward a -Y direction is sometimes referred to as "rear side" in the projector 100.

In the present embodiment, the up-down direction Z, the front-rear direction Y, and the left-right direction X are merely names for explaining a disposition relationship among constituent members of the projector 100 and do not define actual installation postures and directions in the projector 100.

The exterior housing 140 is a box-shaped member having a generally rectangular parallelepiped shape and being hollow on the inside. The exterior housing 140 houses, on the inside thereof, the light source device 110, the image forming device 120, the projection optical device 130, the first speaker device 150, the second speaker device 160, and the cooling device 170.

The exterior housing 140 includes a front side wall section 41, a top wall section 42, a right side wall section 43, a left side wall section 44, a rear side wall section 45, and a bottom wall section 46. Note that, in FIG. 1, the top wall section 42 is illustrated as a transparent member in order to illustrate an internal structure of the exterior housing 140.

In the exterior housing 140, the front side wall section 41 is a plate material located in the +Y direction, which is the front side in the front-rear direction Y, the top wall section 42 is a plate material located in the +Z direction, which is the upper side in the up-down direction Z, the right side wall section 43 is a plate material located in the +X direction, which is the right side in the left-right direction X, the left side wall section 44 is a plate material located in the -X direction, which is the left side in the left-right direction X, the rear side wall section 45 is a plate material located in the -Y direction, which is the rear side in the front-rear direction Y, and the bottom wall section 46 is a plate material located in the -Z direction, which is the lower side in the up-down direction Z.

The front side wall section 41 is a wall facing a screen SCR, which is a projection surface onto which an image is projected from the projector 100. The front side wall section 41 and the rear side wall section 45 are disposed in parallel to an XZ plane and are disposed to face each other. The rear side wall section 45 faces the side opposite to the front side wall section 41 in the front-rear direction Y extending along the Y axis.

The right side wall section 43 and the left side wall section 44 are disposed in parallel to a YZ plane and are disposed to face each other. The right side wall section 43 and the left side wall section 44 face opposite sides each other in the left-right direction X extending along an X-axis orthogonal to the Y-axis.

The top wall section 42 and the bottom wall section 46 are disposed parallel to an XY plane and are disposed to face each other. The top wall section 42 and the bottom wall section 46 face opposite sides each other in the up-down direction Z extending along a Z-axis orthogonal to the X-axis and the Y-axis.

The projector 100 in the present embodiment is installed in a state in which the bottom wall section 46 of the exterior housing 140 faces a projector installation surface, for example, a table upper surface. That is, the top wall section 42 is located opposite to the bottom wall section 46 facing the projector installation surface.

The front side wall section 41, the right side wall section 43, the left side wall section 44 and the top wall section 42 are disposed to intersect each other, specifically, to be orthogonal to each other. The front side wall section 41, the right side wall section 43, and the left side wall section 44 and the bottom wall section 46 are disposed to intersect each other, specifically, to be orthogonal to each other.

The light source device 110 includes a blue light emitting unit 110B that emits blue light LB, a green light emitting unit 110G that emits green light LG, and a red light emitting unit 110R that emits red light LR. The blue light emitting unit 110B includes, for example, a light emitting element that emits the blue light LB having a blue wavelength band of 420 nm to 500 nm and a parallelizing element that parallelizes the blue light LB. The green light emitting unit 110G includes, for example, a light emitting element that emits the green light LG having a green wavelength band of 500 nm to 600 nm and a parallelizing element that parallelizes the green light LG. The red light emitting unit 110R includes, for example, a light emitting element that emits the red light LR having a red wavelength band of 610 nm to 700 nm and a parallelizing element that parallelizes the red light LR.

The image forming device 120 includes a blue light modulation unit 120B, a green light modulation unit 120G, a red light modulation unit 120R, and a light combining optical system 121.

The blue light modulation unit 120B includes a liquid crystal panel 120BP and not-illustrated polarizing plates respectively provided on an incident side and an emission side of the liquid crystal panel 120BP. The blue light modulation unit 120B modulates, according to an image signal, the blue light LB made incident from the blue light emitting unit 110B.

The green light modulation unit 120G includes a liquid crystal panel 120GP and not-illustrated polarizing plates respectively provided on an incident side and an emission side of the liquid crystal panel 120GP. The green light modulation unit 120G modulates, according to an image signal, the green light LG made incident from the green light emitting unit 110G.

The red light modulation unit 120R includes a liquid crystal panel 120RP and not-illustrated polarizing plates respectively provided on an incident side and an emission side of the liquid crystal panel 120RP. The red light modulation unit 120R modulates, according to an image signal, the red light LR made incident from the red light emitting unit 110R.

The light combining optical system 121 includes a cross dichroic prism having a substantially cubic shape. The light combining optical system 121 generates full-color image light GW obtained by combining image lights of colors received from the light modulation units 120B, 120G, and 120R. The image forming device 120 emits the combined full-color image light GW toward the projection optical device 130.

The projection optical device 130 enlarges and projects the image light GW emitted from the image forming device 120 toward the screen SCR. The light is projected from the projection optical device 130, whereby an enlarged color image is displayed on the screen SCR. The projection optical device 130 includes a not-illustrated plurality of projection lenses. The number of projection lenses configuring the projection optical device 130 is not limited.

In the case of the present embodiment, the projection optical device 130 is disposed on the front side wall section 41 of the exterior housing 140. In the present embodiment, the distal end surface of the projection optical device 130 protrudes more than the surface of the front side wall section 41 of the exterior housing 140. However, the distal end surface may be located flush with or on the inner side of the surface of the front side wall section 41 of the exterior housing 140.

In the projector 100 in the present embodiment, a heat generating member that generates heat when being driven is housed on the inside of the exterior housing 140. In the case of the present embodiment, as the heat generating member, for example, the color light emitting units 110B, 110G, and 110R of the light source device 110 and the light modulation units 120B, 120G, and 120R of the image forming device 120 can be exemplified.

The cooling device 170 includes a first fan 171, a second fan 172, a duct member 173, a first heat radiation member 174, and a second heat radiation member 175.

The first fan 171 takes cooling air K into a main housing region A1 of the exterior housing 140. The main housing region A1 is a region for housing the light source device 110 and the image forming device 120, which are main elements of the projector 100. The first fan 171 supplies the cooling air K toward the light modulation units 120B, 120G, and 120R of the image forming device 120. The first fan 171 supplies the cooling air K toward a not-illustrated heat radiation member of the blue light emitting unit 110B having a small heat generation amount in the light source device 110.

The second fan 172 takes the cooling air K into the duct member 173 provided in the exterior housing 140. The duct member 173 guides the cooling air K sucked by the first fan 171 to the first heat radiation member 174 and the second heat radiation member 175 in order. The cooling air K having passed through the second heat radiation member 175 is discharged to the outside via an exhaust opening 145 provided in the rear side wall section 45.

As the first fan 171 and the second fan 172, for example, a centrifugal fan or a sirocco fan can be used.

In the case of the present embodiment, the first heat radiation member 174 is, for example, a heat sink thermally coupled to the red light emitting unit 110R of the light source device 110. The second heat radiation member 175 is disposed at a latter stage of the first heat radiation member 174 and is, for example, a heat sink thermally coupled to the green light emitting unit 110G of the light source device 110.

The first speaker device 150 is disposed to face the inner surface of the right side wall section 43 of the exterior housing 140. In the case of the present embodiment, the first speaker device 150 is located in a gap S1 between a part of a side wall 173a of the duct member 173 and the right side wall section 43. With this configuration, even when the cooling device 170 is provided, it is possible to suppress not only an increase in the size of the exterior housing 140 but also an increase in the size of the projector 100 by effectively using a space in the exterior housing 140.

The right side wall section 43 includes, in a portion facing the first speaker device 150, a first speaker opening section 143 including a plurality of openings. The first speaker opening section 143 is an opening for taking out, to the outside, a first sound wave SW1 emitted from the first speaker device 150. The first speaker opening section 143 includes the plurality of openings.

The first speaker device 150 includes a first speaker 151, a low-pitched sound output unit 152, and a speaker housing 153.

The first speaker 151 is a full range speaker that emits the first sound wave SW1 including a frequency band from low-pitched sound to high-pitched sound. The first speaker 151 includes a diaphragm 151a and a yoke 151b. The diaphragm 151a includes a first output surface 151M that outputs the first sound wave SW1 with its own vibration. The yoke 151b configures a part of a magnetic circuit and functions as a base member that supports the entire first speaker 151. The first speaker 151 includes a voice coil and a magnet besides the elements explained above. However, since the voice coil, the magnet, and the like are components of a general speaker, explanation thereof is omitted.

The low-pitched sound output unit 152 causes the speaker housing 153 to output a frequency band on a low-pitched range side of the first sound wave SW1 emitted by the first speaker 151. The low-pitched sound output unit 152 in the present embodiment includes a pair of passive radiators 152a. The low-pitched sound output unit 152 is not limited to the passive radiator and may be, for example, a bass reflex type. Unlike the first speaker 151, each of the pair of passive radiators 152a includes only a diaphragm and does not include a magnetic circuit. The pair of passive radiators 152a respectively includes output surfaces 152M that output sound waves. The pair of passive radiators 152a is provided back to back to direct the respective output surfaces 152M in opposite directions.

The speaker housing 153 supports the first speaker 151 and the pair of passive radiators 152a. The speaker housing 153 functions as an enclosure that improves sound quality by covering the rear surface of the first speaker 151. The inside of the speaker housing 153 is a sealed space. For this reason, even if the pair of passive radiators 152a does not include a magnetic circuit, the pair of passive radiators 152a functions as a low-pitched sound output unit that enhances and outputs low-pitched sound of the first sound wave SW1 by receiving air vibration caused on the inside of the speaker housing 153 when the first speaker 151 operates and vibrating.

The first speaker device 150 is disposed on the inside of the exterior housing 140 such that the first output surface 151M and the output surface 152M of one of the pair of passive radiators 152a face the right side (the +X side). For this reason, the first speaker device 150 emits the first sound wave SW1 in the right direction (the +X direction). In the present embodiment, the right direction (the +X direction) is equivalent to a "first direction".

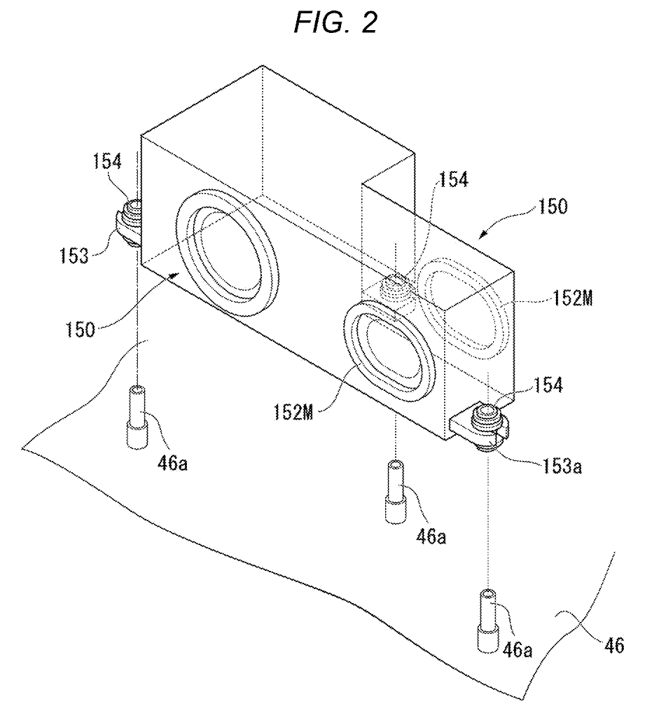

FIG. 2 is a perspective view illustrating a main part of an attachment structure for the first speaker device 150 and the exterior housing 140.

As illustrated in FIG. 2, the speaker housing 153 of the first speaker device 150 is attached to the exterior housing 140 in a plurality of parts via bush members 154 attached to bush attachment sections 153a. The bush members 154 attach the speaker housing 153 to the bottom wall section 46 by being inserted into projections 46a provided on the bottom wall section 46.

The bush members 154 attach the first speaker device 150 to the exterior housing 140 and function as external force absorbers that absorb vibration of the first speaker device 150. The bush members 154 are made of an elastic material such as rubber or resin.

With this configuration, vibration caused by, in particular, the low-pitched range frequency band of the first sound wave SW1 emitted from the first speaker device 150 can be absorbed by the bush members 154. Thus, it is possible to suppress occurrence of noise due to the vibration of the first speaker device 150.

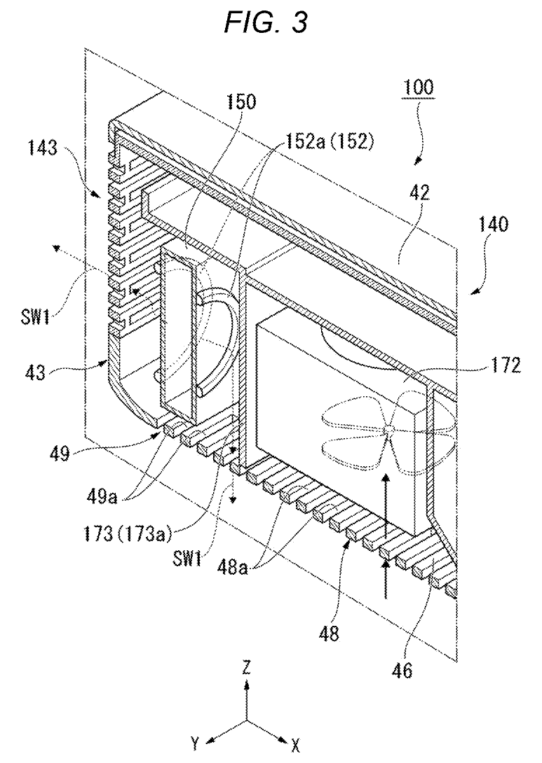

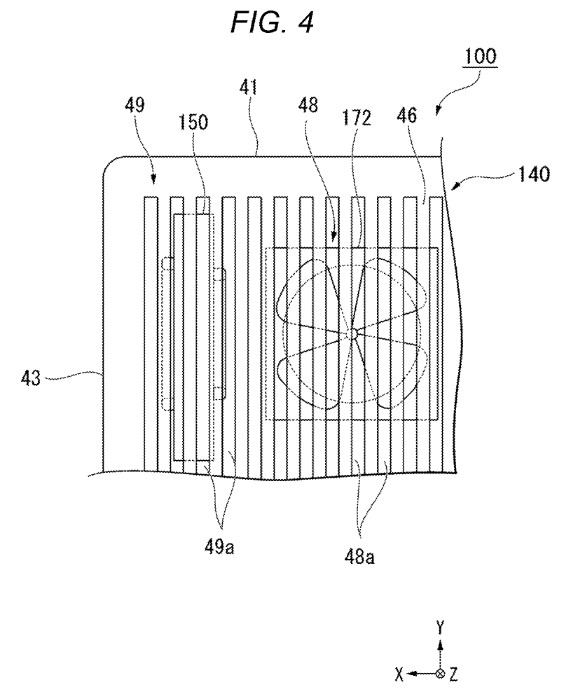

FIG. 3 is a cross-sectional view by a III-III line arrow view of FIG. 1. FIG. 4 is a plan view illustrating a main part configuration of the bottom wall section 46.

As illustrated in FIGS. 3 and 4, the bottom wall section 46 of the exterior housing 140 includes a first opening section 48 and a second opening section 49.

The first opening section 48 includes a plurality of first openings 48a provided at positions facing the first fan 171 and functions as an intake port for taking the cooling air K sucked by the first fan 171 into the inside of the exterior housing 140. Accordingly, the cooling air K can be efficiently taken into the inside of the exterior housing 140 via the first opening section 48.

The second opening section 49 includes a plurality of second openings 49a provided at positions facing the first speaker device 150 and functions as an opening for taking out, to the outside of the exterior housing 140, the first sound wave SW1 emitted from the first speaker device 150. Accordingly, it is possible to efficiently take out, to the outside of the exterior housing 140, via the second opening section 49, low-pitched sound generated from the passive radiator 152a facing the side wall 173a of the duct member 173 in the first speaker device 150.

As illustrated in FIG. 4, the first opening section 48 and the second opening section 49 are provided in the bottom wall section 46 to be adjacent to each other. With this configuration, since the openings of the first opening section 48 and the second opening section 49 are adjacent to each other to be continuously disposed side by side, the appearance of the bottom wall section 46, that is, the design properties of the projector 100 can be improved as compared with when the openings are irregularly disposed side by side.

As illustrated in FIG. 1, the second speaker device 160 is disposed to face the inner surface of the left side wall section 44 of the exterior housing 140. The second speaker device 160 includes a second speaker 161. The second speaker 161 is a tweeter that emits a second sound wave SW2, which is at least a frequency band on a high-pitched range side of the first sound wave SW1 emitted by the first speaker 151, specifically, mid-high-pitched sound.

The second speaker device 160 does not include a speaker housing. The second speaker 161 is not supported by the speaker housing 153 of the first speaker device 150. As explained above, the second speaker device 160 is not housed in the speaker housing 153 of the first speaker device 150. The second speaker device 160 is provided independently of the first speaker device 150. The second speaker device 160 is smaller compared with the first speaker device 150.

The second speaker device 160 is disposed in a gap S2 formed between the light source device 110 and the left side wall section 44 of the exterior housing 140. Specifically, the second speaker device 160 is disposed in a dead space formed between a left rear corner section 47R to which the left side wall section 44 and the rear side wall section 45 of the exterior housing 140 are coupled and the light source device 110. With this configuration, since the space in the exterior housing 140 is effectively used, it is possible to suppress not only an increase in the size of the exterior housing 140 but also an increase in the size of the projector 100.

The left side wall section 44 includes a second speaker opening section 144 in a portion facing the second speaker device 160. The second speaker opening section 144 is an opening for taking out, to the outside, the second sound wave SW2 emitted from the second speaker device 160. The second speaker opening section 144 includes a plurality of openings.

The second speaker 161 emits sound in a frequency band different from the frequency band of the sound emitted by the first speaker 151 but has the same configuration as the first speaker 151 and includes a second output surface 161M that outputs the second sound wave SW2. The second speaker 161 is fixed to the exterior housing 140 via a not-illustrated holding member.

The second speaker device 160 is disposed on the inside of the exterior housing 140 such that the second output surface 161M faces the left side (the -X side). For this reason, the second speaker device 160 emits the second sound wave SW2 in the left direction (the -X direction). In the present embodiment, the left direction (the -X direction) is equivalent to a "second direction".

In the projector 100 in the present embodiment, the first direction (the +X direction) in which the first speaker device 150 emits the first sound wave SW1 and the second direction (the -X direction) in which the second speaker device 160 emits the second sound wave SW2 are respectively different from the front-rear direction Y, which is a projection direction of the image light GW in the projection optical device 130. In the case of the present embodiment, the first direction (the +X direction) and the second direction (the -X direction) are respectively orthogonal to the front-rear direction Y and face opposite directions each other. For this reason, an angle formed by the first direction (the +X direction) and the second direction (the -X direction) is 90 degrees or more, specifically, 180 degrees.

The first sound wave SW1 output from the first output surface 151M mainly includes mid-high-pitched sound and the first sound wave SW1 output from the output surface 152M of the passive radiator 152a mainly includes low-pitched sound. In the first sound wave SW1, mid-high-pitched sound is a sound wave having strong directivity and low-pitched sound is a sound wave having weak directivity.

For this reason, the mid-high-pitched sound of the first sound wave SW1 emitted from the first speaker device 150 spreads to the right side (the +X side) of the projector 100. Since the low-pitched sound of the first sound wave SW1 emitted from the first speaker device 150 has weak directivity, the first sound wave SW1 spreads in all directions of the projector 100. A direction in which a sound wave is emitted in the present specification may be replaced with a normal direction of an output surface of a passive radiator.

The second sound wave SW2 output from the second output surface 161M is a sound wave of mid-high-pitched sound having strong directivity. For this reason, the second sound wave SW2 emitted from the second speaker device 160 spreads to the left side (the -X side) of the projector 100.

As explained above, the projector 100 in the present embodiment includes the light source device 110, the image forming device 120 that generates image light from light emitted from the light source device 110, the projection optical device 130 that projects the image light GW emitted from the image forming device 120, the first speaker device 150 that emits the first sound wave SW1, and the second speaker device 160 that is provided independently of the first speaker device 150 and emits the second sound wave SW2. The first speaker device 150 includes the first speaker 151 that emits the first sound wave SW1 and the speaker housing 153 that supports the first speaker 151. The second speaker device 160 includes the second speaker 161 that is not supported by the speaker housing 153 and emits the second sound wave SW2 including mid-high-pitched sound of the first sound wave SW1. The right direction (the +X direction), which is the first direction in which the first speaker device 150 emits the first sound wave SW1, and the left direction (the -X direction), which is the second direction in which the second speaker device 160 emits the second sound wave SW2, are respectively different from the projection direction of the image light GW in the projection optical device 130. The angle formed by the first direction and the second direction is 90 degrees or more. In the case of the present embodiment, the angle formed by the first direction and the second direction is 180 degrees.

With the projector 100 in the present embodiment, by separately providing the first speaker device 150 and the second speaker device 160 that emit sound waves in two different directions from the exterior housing 140, it is possible to reduce the projector 100 in size as compared with the configuration of the related art in which one large speaker device is provided. Since the first speaker device 150 and the second speaker device 160 respectively emit the sound waves in the directions different from the projection direction of the image light GW, it is possible to provide a projector in which both of a reduction in the size of a device configuration and improvement of sound quality are achieved.

In the projector 100 in the present embodiment, since the first speaker device 150 and the second speaker device 160 are provided on both the sides in the left-right direction X of the exterior housing 140, it is possible to emit mid-high-pitched sound toward both the sides in the left-right direction X. Since the first speaker device 150 includes the low-pitched sound output unit 152 to emit low-pitched sound with weak directivity, it is possible to emit the low-pitched sound in all the directions of the projector 100.

Therefore, the projector 100 in the present embodiment can cause a viewer to hear stereo sound in all the pitch ranges including the low-pitched range to the mid-high-pitched range with respect to the periphery of the projector 100.

The technical scope of the present disclosure is not limited to the embodiment explained above and various changes can be made thereto without departing from the scope of the present disclosure.

Besides, specific description of the shapes, the numbers, the dispositions, the materials, and the like of the elements of the speaker devices and the projector are not limited to those in the embodiment explained above and can be changed as appropriate. The embodiment is explained above with reference to the example in which the projector of the present disclosure is applied to the projector in which the liquid crystal panel is used. However, the projector is not limited thereto. The projector of the present disclosure may be applied to a configuration in which a digital micromirror device is used as a light modulation unit. The projector may not include a plurality of light modulation units and may include only one light modulation unit.

The embodiment is explained above with reference to the example in which the second speaker device 160 does not include a speaker housing and includes the second speaker 161 alone. However, the second speaker device 160 may include a speaker housing provided independently of the first speaker device 150. That is, the second speaker device 160 may include a speaker housing separate from the speaker housing 153 of the first speaker device 150. With this configuration, since the speaker housing of the second speaker device 160 functions as an enclosure, the sound quality of the second speaker 161 can be improved.

The embodiment is explained above with reference to the example in which the first speaker device 150 and the second speaker device 160 are disposed to face opposite to each other in the left-right direction X (the angle formed by the first direction and the second direction is 180 degrees). However, the layout of the first speaker device 150 and the second speaker device 160 is not limited thereto.

In the first speaker device 150 and the second speaker device 160, the angle formed by the first direction and the second direction in which the first speaker device 150 and the second speaker device 160 emit sound waves only has to be 90 degrees or more. For example, the first speaker device 150 may emit the first sound wave SW1 toward any one side in the left-right direction X and the second speaker device 160 may emit the second sound wave SW2 toward the rear side (-Y) in the front-rear direction Y. Alternatively, the positions of the first speaker device 150 and the second speaker device 160 may be interchanged. In this case, the output surfaces of the first speaker device 150 and the second speaker device 160 may be installed to be tilted with respect to the surfaces of the wall sections of the exterior housing 140.

The embodiment is explained above with reference to the example in which the first speaker device 150 is the full range speaker and the second speaker device 160 is the tweeter that emits mid-high-pitched sound. However, the present disclosure is not limited thereto. In the present disclosure, if the second speaker device 160 is provided independently of the first speaker device 150, the second speaker device 160 may not emit only the mid-high-pitched sound and may include the full range speaker like the first speaker device 150.

The embodiment is explained above with reference to the example in which the first speaker device 150 emits the first sound wave SW1 in the right direction (the +X direction) and the second speaker device 160 emits the second sound wave SW2 in the left direction (the -X direction). That is, the embodiment is explained with reference to the example in which the first speaker device 150 and the second speaker device 160 are disposed such that the first output surface 151M and the second output surface 161M are orthogonal to the X axis. However, the directions of the first speaker device 150 and the second speaker device 160 are not limited thereto. The first speaker device 150 and the second speaker device 160 may be disposed in a state in which the first output surface 151M and the second output surface 161M are slightly inclined to face any direction of the front-rear direction Y. For example, when the first output surface 151M and the second output surface 161M are slightly inclined to face the front side (the +Y side), it is possible to provide higher sound quality to a viewer present on the front side (the +Y side) of the projector. When the first output surface 151M and the second output surface 161M are slightly inclined to face the rear side (the -Y side), it is possible to provide higher sound quality to a viewer present on the rear side (the -Y side) of the projector.

In the embodiment explained above, the output surfaces of the first speaker device 150 and the second speaker device 160 may be inclined in the up-down direction Z. That is, the output surfaces of the first speaker device 150 and the second speaker device 160 may be inclined with respect to the Z axis in a virtual plane formed by a plane extending along the XZ plane.

A summary of the present disclosure is appended below.

### Appendix 1

A projector including: a light source device; an image forming device configured to generate image light from light emitted from the light source device; a projection optical device configured to project the image light emitted from the image forming device; a first sound wave generation device configured to emit a first sound wave; and a second sound wave generation device provided independently of the first sound wave generation device and configured to emit a second sound wave, wherein the first sound wave generation device includes: a first speaker configured to emit the first sound wave; and a speaker housing supporting the first speaker, the second sound wave generation device includes a second speaker not supported by the speaker housing and configured to emit the second sound wave, a first direction in which the first sound wave generation device emits the first sound wave and a second direction in which the second sound wave generation device emits the second sound wave are respectively different from a projection direction of the image light in the projection optical device, and an angle formed by the first direction and the second direction is 90 degrees or more.

With the projector having this configuration, since the first sound wave generation device and the second sound wave generation device that emit sound waves in two different directions from the exterior housing are independently provided separately from each other, it is possible to reduce the projector in size as compared with the configuration of the related art in which one large speaker device is provided. Since each of the first sound wave generation device and the second sound wave generation device emits the sound wave in the direction different from the projection direction of the image light, it is possible to provide the projector in which both of a reduction in the size of a device configuration and improvement of sound quality are achieved.

### Appendix 2

The projector described in Appendix 1, wherein the second sound wave emitted by the second speaker includes at least a frequency band on a high-pitched range side of the first sound wave.

With this configuration, since at least high-pitched sound is emitted from the second speaker together with the first speaker, it is possible to cause a viewer to hear high-quality stereo sound.

### Appendix 3

The projector described in Appendix 1 or 2, wherein the first direction and the second direction are respectively orthogonal to the projection direction, and an angle formed by the first direction and the second direction is 180 degrees.

With this configuration, since the first sound wave generation device and the second sound wave generation device are provided on both sides of the exterior housing, it is possible to emit sound from the exterior housing toward both the sides. Thus, it is possible to emit high-quality sound toward the periphery of the projector.

### Appendix 4

The projector according to any one of Appendices 1 to 3, wherein the first sound wave generation device further includes a low-pitched sound output unit that causes the speaker housing to output a frequency band on a low-pitched range side of the first sound wave.

With this configuration, it is possible to cause the first sound wave generation device to function as a full range speaker that emits the first sound wave including low-pitched sound to mid-high-pitched sound.

### Appendix 5

The projector according to any one of Appendices 1 to 4, further including an exterior housing that houses the light source device, the image forming device, the projection optical device, the first sound wave generation device, and the second sound wave generation device, wherein the second speaker is supported by the exterior housing.

With this configuration, since the constituent members of the projector are housed on the inside of the exterior housing, it is possible to improve the design properties of the projector as compared with a configuration in which a speaker is exposed to the outside of the exterior housing.

### Appendix 6

The projector described in Appendix 5, wherein the second sound wave generation device is located in a gap between the light source device and the exterior housing.

With this configuration, it is possible to suppress not only an increase in the size of the exterior housing but also an increase in the size of the projector by effectively using a space in the exterior housing.

### Appendix 7

The projector described in Appendix 5 or 6, wherein the speaker housing of the first sound wave generation device is attached to the exterior housing via a bush member that absorbs vibration.

With this configuration, it is possible to absorb, with the bush member, vibration caused by, in particular, a low-pitched range frequency band of the first sound wave emitted from the first sound wave generation device. Thus, it is possible to suppress occurrence of noise due to vibration of the first sound wave generation device.

### Appendix 8

The projector according to any one of Appendices 5 to 7, further including a cooling device configured to take cooling air into an inside of the exterior housing, wherein the cooling device includes a duct member configured to guide the cooling air, and the first sound wave generation device is located in a gap between a part of a side wall of the duct member and the exterior housing.

With this configuration, it is possible to efficiently cool the heat generating member housed in the exterior housing. Even when the projector includes the cooling device, it is possible to suppress an increase in the size of the projector by effectively using the space in the exterior housing.

### Appendix 9

The projector described in Appendix 8, wherein the exterior housing includes a bottom wall section, the bottom wall section includes a first opening section for taking the cooling air into the inside of the exterior housing and a second opening section for taking out the first sound wave emitted from the first sound wave generation device, and the first opening section and the second opening section are provided in the bottom wall section to be adjacent to each other.

With this configuration, since the first opening section and the second opening section are adjacent to each other to be continuously disposed side by side, it is possible to improve the appearance of the bottom wall section, that is, the design properties of the projector as compared with when the opening sections are irregularly disposed.

What is claimed is:

1. A projector comprising:
a light source device;
an image forming device configured to generate image light from light emitted from the light source device;
a projection optical device configured to project the image light emitted from the image forming device;
a first sound wave generation device configured to emit a first sound wave; and
a second sound wave generation device provided independently of the first sound wave generation device and configured to emit a second sound wave, wherein
the first sound wave generation device includes:
a first speaker configured to emit the first sound wave; and
a speaker housing supporting the first speaker,
the second sound wave generation device includes a second speaker not supported by the speaker housing and configured to emit the second sound wave,
a first direction in which the first sound wave generation device emits the first sound wave and a second direction in which the second sound wave generation device emits the second sound wave are respectively different from a projection direction of the image light in the projection optical device, and
an angle formed by the first direction and the second direction is 90 degrees or more.

2. The projector according to claim 1, wherein the second sound wave emitted by the second speaker includes at least a frequency band on a high-pitched range side of the first sound wave.

3. The projector according to claim 1, wherein
the first direction and the second direction are respectively orthogonal to the projection direction, and
an angle formed by the first direction and the second direction is 180 degrees.

4. The projector according to claim 1, wherein the first sound wave generation device further includes a low-pitched sound output unit that causes the speaker housing to output a frequency band on a low-pitched range side of the first sound wave.

5. The projector according to claim 1, further comprising an exterior housing that houses the light source device, the image forming device, the projection optical device, the first sound wave generation device, and the second sound wave generation device, wherein
the second speaker is supported by the exterior housing.

6. The projector according to claim 5, wherein the second sound wave generation device is located in a gap between the light source device and the exterior housing.

7. The projector according to claim 5, wherein the speaker housing of the first sound wave generation device is attached to the exterior housing via a bush member that absorbs vibration.

8. The projector according to claim 5, further comprising a cooling device configured to take cooling air into an inside of the exterior housing, wherein
the cooling device includes a duct member configured to guide the cooling air, and
the first sound wave generation device is located in a gap between a part of a side wall of the duct member and the exterior housing.

9. The projector according to claim 8, wherein
the exterior housing includes a bottom wall section,
the bottom wall section includes a first opening section for taking the cooling air into the inside of the exterior housing and a second opening section for taking out the first sound wave emitted from the first sound wave generation device, and
the first opening section and the second opening section are provided in the bottom wall section to be
adjacent to each other.
